(19) United States
(12) Patent Application Publication
(10) Pub. No.: US 2026/0275044 A1
(43) Pub. Date: Sep. 17, 2026

(54) COBALT CATALYZED HYDROFORMYLATION OF VINYL-FUNCTIONAL POLYORGANOSILOXANES

(71) Applicant: Dow Global Technologies LLC, Midland, MI (US)

(72) Inventors: Michael Tulchinsky, Midland, MI (US); Jason Fisk, Midland, MI (US)

(21) Appl. No.: 19/491,429

(22) PCT Filed: Jul. 26, 2024
(86) PCT No.: PCT/US2024/039749

§ 371 Date: Dec. 9, 2025

Related U.S. Application Data
(60) Provisional application No. 63/519,311, filed on Aug. 14, 2023.

(51) Int. Cl. C08G 77/38

(52) U.S. Cl. CPC C08G 77/38

(57) ABSTRACT

A process for preparing a propanal-functional polyorganosiloxane includes contacting carbon monoxide and hydrogen gas and a vinyl-functional polyorganosiloxane with at least 4 siloxane units per molecule in the presence of a cobalt carbonyl catalyst with heating at less than 90° C. and pressure of greater than 150 psi to 700 psi.

### CROSS REFERENCE TO RELATED APPLICATIONS

This application claims the benefit of U.S. Provisional Patent Application Ser. No. 63/519,311 filed on 14 Aug. 2023 under 35 U.S.C. § 119 (e). U.S. Provisional Patent Application Ser. No. 63/519,311 is hereby incorporated by reference.

### FIELD

This invention relates to a process for hydroformylation of vinyl-functional polyorganosiloxanes. More particularly, this invention relates to a process for preparing a propanal-functional polyorganosiloxane via hydroformylation reaction of a polyorganosiloxane having, per molecule, at least one silicon bonded vinyl group and at least 4 siloxane units in the presence of a cobalt carbonyl catalyst.

### INTRODUCTION

WO2022/081444 discloses rhodium catalyzed hydroformylation of organosilicon compounds. However, rhodium catalysts can be costly, and residual rhodium in the product can be detrimental for some applications.

Other references have disclosed hydroformylation of olefins (which do not contain silicon bonded vinyl groups) using various catalysts. Typically, such olefin hydroformylation reaction processes are performed at high temperatures, e.g., ≥140° C.

### SUMMARY

A process for preparing a propanal-functional polyorganosiloxane comprises: combining starting materials comprising (A) a gas comprising hydrogen and carbon monoxide, (B) a vinyl-functional polyorganosiloxane with at least 4 siloxane units per molecule, and (C) a cobalt carbonyl catalyst.

### DETAILED DESCRIPTION

The process for preparing the propanal-functional polyorganosiloxane introduced above is described in detail below. The process comprises:
1) combining starting materials comprising
   (A) the gas comprising hydrogen and carbon monoxide,
   (B) the vinyl-functional polyorganosiloxane with at least 4 siloxane units per molecule,
(C) the cobalt carbonyl catalyst, and
(D) a solvent, thereby preparing a reaction fluid comprising the propanal-functional polyorganosiloxane.

The process may optionally further comprise an additional step before step 1). For example, the process may further comprise step pre-1), where
step pre-1) is forming (C) the cobalt carbonyl catalyst by a method comprising:
   i) combining a cobalt catalyst precursor selected from the group consisting of cobalt (II) acetylacetonate and dicobalt octacarbonyl and a solvent, thereby forming a solution,
   ii) heating the solution at a temperature of 100° C. to 150° C. at a pressure of 600 psi (4136.9 kPa) to 800 psi for a time of 10 minutes to 60 minutes, thereby forming a product comprising the (C) the cobalt carbonyl catalyst, and
   optionally iii) cooling the product comprising (C) the cobalt carbonyl catalyst to 25° C. to 50° C. before step 1).

Without wishing to be bound by theory, it is thought that in the process described herein, (C) the cobalt carbonyl catalyst includes cobalt tetracarbonyl hydride of formula HCo(CO)₄. Starting material (C), the cobalt carbonyl catalyst may be prepared as described above and as exemplified below in Reference Examples 1 and 2. For example, a cobalt catalyst precursor may be used. The cobalt catalyst precursor cobalt (II) acetylacetonate has formula

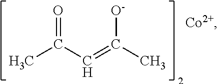

and dicobalt octacarbonyl has formula Co₂(CO)₈, and both are known in the art and are commercially available, e.g., from Sigma Aldrich Inc. of St. Louis, Missouri, USA. The cobalt catalyst precursor may be dissolved in a solvent, such as 1,4-dioxane or other solvents, as described below for starting material (D). In step pre-1), forming (C) the cobalt carbonyl catalyst, step i) and/or step ii) may optionally be performed in the presence of (A) the gas comprising hydrogen and carbon monoxide. Without wishing to be bound by theory, it is thought that by heating the cobalt catalyst precursor a temperature of 100° C. to 150° C. at a pressure of 600 psi (4136.9 kPa) to 800 psi (5515.8 kPa) for a time of 10 min to 60 min, the resulting cobalt carbonyl catalyst forms (e.g., comprising cobalt tetracarbonyl hydride of formula HCo(CO)₄), thereby (C) the cobalt carbonyl catalyst capable of catalyzing hydroformylation reaction of starting materials (A) and (B) in step 1) of the process described herein is prepared.

In step 1), a hydroformylation reaction occurs, wherein the vinyl groups of starting material (B) are reacted with starting material (A) in the presence of starting material (C) to form propanal groups. Combining the starting materials in step 1) may be performed by heating under pressure, optionally with mixing.

In the process described above, a hydroformylation reaction of (B) the vinyl-functional polyorganosiloxane is performed in step 1), thereby preparing the reaction fluid, which comprises the propanal-functional polyorganosiloxane. Step 1) is performed under milder conditions, as compared to other hydroformylation reactions of olefins using cobalt containing catalysts. In step 1), the starting materials may be combined with heating while under pressure for a time sufficient to effect hydroformylation reaction. For example, step 1) may be performed at a temperature of 50° C. to <90° C. Alternatively, the temperature may be 50° C. to 80° C., alternatively 60° C. to 80° C., alternatively 70° C. to 80° C. Alternatively, step 1) may be performed at a temperature of at least 50° C., alternatively at least 55° C., alternatively at least 60° C., alternatively at least 65° C., and alternatively at least 70° C., while at the same time, hydroformylation reaction in step 1) may be performed at a temperature <90° C., alternatively up to 85° C., alternatively up to 80° C., alternatively up to 75° C., and alternatively up to 70° C. Without wishing to be bound by theory, it is thought that the use of (C) the cobalt carbonyl catalyst at these relatively low temperatures provides the benefit of minimizing or eliminating crosslinking and/or degradation of the propanal groups formed via the hydroformylation reaction.

Step 1) may be performed at a pressure of >150 psi (1034.2 kPa) to 700 psi (4826.3 kPa), alternatively 400 psi (2757.9 kPa) to 700 psi (4826.3 kPa). Alternatively, pressure may be >150 psi (1034.2 kPa), alternatively at least 200 psi (1379.0 kPa), alternatively at least 300 psi (2068.4 kPa), and alternatively at least 400 psi (2757.9 kPa), while at the same time pressure may be up to 700 psi (4826.3 kPa), alternatively up to 600 psi (4136.9 kPa), alternatively up to 500 psi (3447.4 kPa), alternatively up to 400 psi (2757.9 kPa).

Combining the starting materials in step 1) is performed for a time sufficient to effect hydroformylation reaction. The exact time depends on various factors including the selection and vinyl content of (B) the vinyl-functional polyorganosiloxane and the amount of (C) the cobalt carbonyl catalyst, and whether the process is performed in a batch, semi-batch, or continuous mode. However, the time for step 1) may be at least 30 min, alternatively 30 min to 24 h, and alternatively 30 min to 8 h. Alternatively, time may be at least 30 min, alternatively at least 1 h, alternatively at least 2 h, while concurrently, the time may be up to 8 h, alternatively up to 4 h, and alternatively up to 2 h.

The process described herein may be carried out in a batch, semi-batch, or continuous mode, using one or more suitable reactors, such as an agitated batch autoclave or a continuous stirred tank reactor (CSTR). The selections of (B) the vinyl-functional polyorganosiloxane and (C) the cobalt carbonyl catalyst may impact the size and type of reactor used. One reactor, or two or more different reactors, may be used. The process may be conducted in one or more steps, which may be affected by balancing capital costs and achieving high catalyst selectivity, activity, lifetime, and ease of operability, as well as the reactivity of the particular starting materials and reaction conditions selected.

Alternatively, the hydroformylation reaction in the process may be performed in a continuous manner. For example, the process used may be as described in U.S. Pat. No. 10,023,516 except that the olefin feed stream and catalyst described therein are replaced with (B) the vinyl-functional polyorganosiloxane and (C) the cobalt carbonyl catalyst, each described herein.

Step 1) of the process forms a reaction fluid comprising the propanal-functional polyorganosiloxane. The reaction fluid may further comprise additional materials, such as those which have either been deliberately employed, or formed in situ, during step 1) of the process. Examples of such materials that can also be present include unreacted (B) vinyl-functional polyorganosiloxane, unreacted (A) carbon monoxide and hydrogen gases, residual (C) cobalt carbonyl catalyst, and/or in situ formed side products, which may include hydrogenation byproducts as a result of hydrogenating vinyl into ethyl as well as alcohols due to reduction of the forming aldehydes, and/or polymeric aldehyde condensation byproducts, as well as (D) the solvent.

The process may optionally further comprise one or more additional steps after step 1), such as: step 2) recovering (C) the cobalt carbonyl catalyst from the reaction fluid comprising the propanal-functional polyorganosiloxane. Recovering (C) the cobalt carbonyl catalyst may be performed by methods known in the art, including but not limited to distillation or adsorption,

However, one benefit of the process described herein is that (C) the cobalt carbonyl catalyst need not be removed and/or need not be recycled. Due to the level of cobalt needed, and the costs of the propanal-functional polyorganosiloxane and cobalt carbonyl catalyst, it may be more cost effective not to recover and/or recycle (C) the cobalt carbonyl catalyst. The propanal-functional polyorganosiloxane produced by the process may be stable even when (C) the cobalt carbonyl catalyst is not removed. Therefore, alternatively, the process described above may be performed without removal of the cobalt carbonyl catalyst in step 2). Alternatively, when step 2) is present (C) the cobalt carbonyl catalyst may be removed and recycled. Alternatively, (C) the cobalt carbonyl catalyst may be removed and discarded, rather than recycled.

Alternatively, in addition to, or instead of step 2) described above, the process may further comprise 3) purifying the reaction fluid. For example, the propanal-functional polyorganosiloxane may be isolated from the additional materials, described above, by any convenient means such as extraction, and/or stripping and/or distillation, optionally with reduced pressure, e.g., to remove solvent.

### (A) Syngas

Starting material (A), the gas used in the process described herein, comprises carbon monoxide (CO) and hydrogen gas (H₂). For example, the gas may be syngas. As used herein, “syngas” (from synthesis gas) refers to a gas mixture that contains varying amounts of CO and H₂. Production methods are well known and include, for example: (1) steam reforming and partial oxidation of natural gas or liquid hydrocarbons, and (2) the gasification of coal and/or biomass. CO and H₂ typically are the main components of syngas, but syngas may contain carbon dioxide and inert gases such as CH₄, N₂ and Ar. The molar ratio of H₂ to CO (H₂:CO molar ratio) varies greatly but may range from 1:100 to 100:1, alternatively 1:10 and 10:1. Syngas is commercially available and is often used as a fuel source or as an intermediate for the production of other chemicals. Alternatively, CO and H₂ from other sources (i.e., other than syngas) may be used as starting material (A) herein. Alternatively, the H₂:CO molar ratio in starting material (A) for use herein may be 3:1 to 1:3, alternatively 2:1 to 1:2, and alternatively 1:1.

### (B) Vinyl-Functional Polyorganosiloxane

The vinyl-functional polyorganosiloxane has, per molecule, at least one vinyl group covalently bonded to silicon. Alternatively, the vinyl-functional polyorganosiloxane may have, per molecule, more than one vinyl group covalently bonded to silicon. Starting material (B) may be one vinyl-functional polyorganosiloxane. Alternatively, starting material (B) may comprise two or more vinyl-functional polyorganosiloxanes that differ from one another in at least one respect, such as structure, vinyl content, and/or molecular weight.

The vinyl-functional polyorganosiloxane has at least 4 siloxane units per molecule. The vinyl-functional polyorganosiloxane may be cyclic, linear, branched, resinous, or a combination of two or more thereof. Said polyorganosiloxane may comprise unit formula (B1-1): (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(SiO_{4/2})_{g}(ZO_{1/2})ₕ; where each R^{A} is a vinyl group; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; each Z is independently selected from the group consisting of a hydrogen atom and R⁵ (where R⁵ is an alkyl group of 1 to 18 carbon atoms or an aryl group of 6 to 18 carbon atoms), subscripts a, b, c, d, e, f, and g represent average numbers of each unit in formula (B1-1) and have values such that subscript a≥0, subscript b≥0, subscript c≥0, subscript d≥0, subscript e≥0, subscript f≥0, and subscript g≥0; a quantity (a+b+c+d+e+f+g)≥4, and a quantity (b+d+f)≥1, and subscript h has a value such that 0≤h/(e+f+g)≤1.5. At the same time, the quantity (a+b+c+d+e+f+g) may be ≤10,000. Alternatively, in formula (B1-1), each R⁴ may be independently selected from the group consisting of an alkyl group of 1 to 18 carbon atoms, an aryl group of 6 to 18 carbon atoms, and a hydrocarbonoxy-functional group of 1 to 18 carbon atoms. Alternatively, each R⁴ may be independently selected from the group consisting of an alkyl group of 1 to 18 carbon atoms, an aryl group of 6 to 18 carbon atoms, and an alkoxy-functional group of 1 to 18 carbon atoms. Alternatively, each R⁴ may be independently selected from the group consisting of an alkyl group of 1 to 18 carbon atoms and an aryl group of 6 to 18 carbon atoms. Alternatively, each Z may be hydrogen or an alkyl group of 1 to 6 carbon atoms. Alternatively, each Z may be hydrogen.

Suitable alkyl groups for R⁴ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Alternatively, the alkyl group for R⁴ may be selected from the group consisting of methyl, ethyl, propyl and butyl; alternatively methyl, ethyl, and propyl; alternatively methyl and ethyl. Alternatively, the alkyl group for R⁴ may be methyl.

Suitable aryl groups for R⁴ may be monocyclic or polycyclic and may have pendant hydrocarbyl groups. For example, the aryl groups for R⁴ include phenyl, tolyl, xylyl, and naphthyl, benzyl, 1-phenylethyl and 2-phenylethyl. Alternatively, the aryl group for R⁴ may be monocyclic, such as phenyl, tolyl, or benzyl; alternatively the aryl group for R⁴ may be phenyl.

Suitable hydrocarbonoxy-functional groups for R⁴ may have the formula —OR⁵ or the formula —OR³—OR⁵, where each R³ is an independently selected divalent hydrocarbyl group of 1 to 18 carbon atoms, and each R⁵ is independently selected from the group consisting of the alkyl groups of 1 to 18 carbon atoms and the aryl groups of 6 to 18 carbon atoms, which are as described and exemplified above for R⁴. Examples of divalent hydrocarbyl groups for R³ include alkylene group such as ethylene, propylene, butylene, or hexylene; an arylene group such as phenylene, or an alkylarylene group such as:

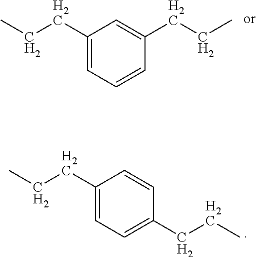

Alternatively, R³ may be an alkylene group such as ethylene. Alternatively, the hydrocarbonoxy-functional group may have the formula —OR⁵ and may be an alkoxy-functional group such as methoxy, ethoxy, propoxy, or butoxy; alternatively methoxy or ethoxy, and alternatively methoxy.

Suitable acyloxy groups for R⁴ may have the formula

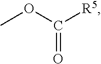

where R⁵ is as described above. Examples of suitable acyloxy groups include acetoxy.

Alternatively, (B) the vinyl-functional polyorganosiloxane may comprise (B1-2) a linear polydiorganosiloxane having, per molecule, at least one vinyl group; alternatively at least two vinyl groups (e.g., when in formula B1-1) above, subscripts e=f=g=0). For example, said polydiorganosiloxane may comprise unit formula (B1-3):
(R⁴₃SiO_{1/2})ₐ(R⁴₂R^{A}SiO_{1/2})_{b}(R⁴₂SiO_{2/2})_{c}(R⁴R^{A}SiO_{2/2})_{d}, where R^{A} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥4. Alternatively, in unit formula (B1-3) the quantity (a+b+c+d) may be at least 4, alternatively at least 10, alternatively at least 50, alternatively at least 100, and alternatively at least 140. At the same time in unit formula (B1-3), the quantity (a+b+c+d) may be less than or equal to 10,000; alternatively less than or equal to 4,000; alternatively less than or equal to 2,000; alternatively less than or equal to 1,000; alternatively less than or equal to 750; alternatively less than or equal to 700. Alternatively, in unit formula (B1-3) each R⁴ may be independently selected from the group consisting of alkyl and aryl; alternatively methyl and phenyl. Alternatively, each R⁴ in unit formula (B1-3) may be an alkyl group; alternatively each R⁴ may be methyl.

Alternatively, the polydiorganosiloxane of unit formula (B1-3) may be selected from the group consisting of: unit formula (B1-4): (R⁴₂R^{A}SiO_{1/2})₂(R⁴₂SiO_{2/2})ₘ(R⁴R^{A}SiO_{2/2})ₙ, unit formula (B1-5): (R⁴₃SiO_{1/2})₂(R⁴₂SiO_{2/2})ₒ(R⁴R^{A}SiO_{2/2})ₚ, or a combination of both (B1-4) and (B1-5). In formulae (B1-4) and (B1-5), each R⁴ and R^{A} are as described above. Subscript m may be 0 or a positive number. Alternatively, subscript m may be at least 2. Alternatively subscript m be 2 to 1,000. Subscript n may be 0 or a positive number. Alternatively, subscript n may be 0 to 2000. However, a quantity (m+n) is at least 2, alternatively 140≤(m+n)≤700. Subscript o may be 0 or a positive number. Alternatively, subscript o may be 0 to 2000. Subscript p is at least 2. Alternatively subscript p may be 2 to 2000. However, a quantity (o+p) is at least 2, alternatively 140≤(o+p)≤700.

Starting material (B) may comprise a vinyl-functional polydiorganosiloxane such as i) bis-dimethylvinylsiloxy-terminated polydimethylsiloxane, ii) bis-dimethylvinylsiloxy-terminated poly(dimethylsiloxane/methylvinylsiloxane), iii) bis-dimethylvinylsiloxy-terminated polymethylvinylsiloxane, iv) bis-trimethylsiloxy-terminated poly(dimethylsiloxane/methylvinylsiloxane), v) bis-trimethylsiloxy-terminated polymethylvinylsiloxane, vi) bis-dimethylvinylsiloxy-terminated poly(dimethylsiloxane/methylphenylsiloxane/methylvinylsiloxane), vii) bis-dimethylvinylsiloxy-terminated poly(dimethylsiloxane/methylphenylsiloxane), viii) bis-dimethylvinylsiloxy-terminated poly(dimethylsiloxane/diphenylsiloxane), ix) bis-phenyl,methyl,vinyl-siloxy-terminated polydimethylsiloxane, and x) a combination of two or more of i) to ix).

Methods of preparing linear vinyl-functional polydiorganosiloxanes described above for starting material (B), such as hydrolysis and condensation of the corresponding organohalosilanes and oligomers or equilibration of cyclic polydiorganosiloxanes, are known in the art, see for example U.S. Pat. Nos. 3,284,406; 4,772,515; 5,169,920; 5,317,072; and 6,956,087, which disclose preparing linear polydiorganosiloxanes with vinyl groups. Examples of linear polydiorganosiloxanes having vinyl groups are commercially available from, e.g., Gelest Inc. of Morrisville, Pennsylvania, USA under the tradenames DMS-V00, DMS-V03, DMS-V05, DMS-V21, DMS-V22, DMS-V25, DMS-V-31, DMS-V33, DMS-V34, DMS-V35, DMS-V41, DMS-V42, DMS-V43, DMS-V46, DMS-V51, and DMS-V52.

Alternatively, (B) the vinyl-functional polyorganosiloxane may be cyclic, e.g., when in unit formula (B1-1), subscripts a=b=c=e=f=g=h=0. The cyclic vinyl-functional polydiorganosiloxane may have unit formula (B1-6): (R⁴R^{A}SiO_{2/2})_{d}, where R^{A} and R⁴ are as described above, and subscript d may be 3 to 12, alternatively 3 to 6, and alternatively 4 to 5. Examples of cyclic vinyl-functional polydiorganosiloxanes include 2,4,6-trimethyl-2,4,6-trivinyl-cyclotrisiloxane, 2,4,6,8-tetramethyl-2,4,6,8-tetravinyl-cyclotetrasiloxane, 2,4,6,8,10-pentamethyl-2,4,6,8,10-pentavinyl-cyclopentasiloxane, and 2,4,6,8,10,12-hexamethyl-2,4,6,8,10,12-hexavinyl-cyclohexasiloxane. These cyclic vinyl-functional polydiorganosiloxanes are known in the art and are commercially available from, e.g., Sigma-Aldrich of St. Louis, Missouri, USA; Milliken of Spartanburg, South Carolina, USA; and other vendors.

Alternatively, the cyclic vinyl-functional polydiorganosiloxane may have unit formula (B1-7): (R⁴₂SiO_{2/2})_{c}(R⁴R^{A}SiO_{2/2})_{d}, where R⁴ and R^{A} are as described above, subscript c is 0 to 6, alternatively >0 to 6, and subscript d is 3 to 12. Alternatively, in formula (B1-7), c may be 3 to 6, and d may be 3 to 6.

Alternatively, (B) the vinyl-functional polyorganosiloxane may be branched. The branched vinyl-functional polyorganosiloxane may have general formula (B1-8): R^{A}SiR¹²₃, where R^{A} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]: OSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100; with the proviso that R¹², R¹⁴, and R¹⁵ are selected such that the branched vinyl-functional polyorganosiloxane has at least 4 silicon atoms per molecule. At least two of R¹² may be —OSi(R¹⁴)₃. Alternatively, all three of R¹² may be —OSi(R¹⁴)₃.

Alternatively, in formula (B1-8) when each R¹² is —OSi(R¹⁴)₃, each R¹⁴ may be —OSi(R¹⁵)₃ moieties such that the branched vinyl-functional polyorganosiloxane has the following structure (B1-9):

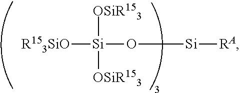

where R^{A} and R¹⁵ are as described above. Alternatively, each R¹⁵ may be an R¹³, as described above, and each R¹³ may be methyl.

Alternatively, in formula (B1-8), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched vinyl-functional polyorganosiloxane has the following structure (B1-10):

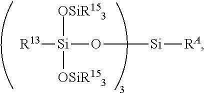

where R^{A}, R¹³, and R¹⁵ are as described above. Alternatively, each R¹⁵ may be an R¹³, and each R¹³ may be methyl.

Alternatively, in formula (B1-8), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of R¹² are —OSiR¹³(R¹⁴)₂. Alternatively, each R¹⁴ in —OSiR¹³(R¹⁴)₂ may be —OSi(R¹⁵)₃ such that the branched vinyl-functional polyorganosiloxane has the following structure (B1-11):

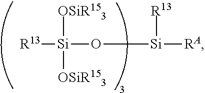

where R^{A}, R¹³, and R¹⁵ are as described above. Alternatively, each R¹⁵ may be an R¹³, and each R¹³ may be methyl. Alternatively, the vinyl-functional branched polyorganosiloxane may have 3 to 16 silicon atoms per molecule, alternatively 4 to 16 silicon atoms per molecule, and alternatively 4 to 10 silicon atoms per molecule. Examples of branched vinyl-functional polyorganosiloxanes include (1,1,1,3,5,7,9,9,9-nonamethyl-3,7-bis((trimethylsilyl)oxy)-5-vinylpentasiloxane), which has formula

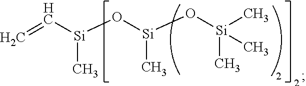

and 3-(5-((1,1,1,3,5,5,5-heptamethyltrisiloxan-3-yl)oxy)-1,1,1,3,7,9,9,9-octamethyl-3,7-bis((trimethylsilyl)oxy)-5-vinylpentasiloxane), which has formula

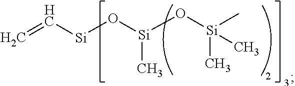

Branched vinyl-functional polyorganosiloxanes described above may be prepared by known methods, such as those disclosed in “Testing the Functional Tolerance of the Piers-Rubinsztajn Reaction: A new Strategy for Functional Silicones” by Grande, et al. Supplementary Material (ESI) for Chemical Communications, @ The Royal Society of Chemistry 2010.

Alternatively, (B) the vinyl-functional polyorganosiloxane may be branched, such as the branched vinyl-functional polyorganosiloxane with the dendrimeric structures described above and/or a branched vinyl-functional polyorganosiloxane that may have, e.g., more vinyl groups per molecule and/or more polymer units than the branched vinyl-functional polyorganosiloxane described above. Alternatively, the branched vinyl-functional polyorganosiloxane may have (in formula (B1-1)) a quantity (e+f+g) sufficient to provide >0 to 5 mol % of trifunctional and/or quadrifunctional units to the branched vinyl-functional polyorganosiloxane.

For example, the branched vinyl-functional polyorganosiloxane may comprise a Q branched polyorganosiloxane of unit formula (B1-12):
(R⁴₃SiO_{1/2})_{q}(R⁴₂R^{A}SiO_{1/2})ᵣ(R⁴₂SiO_{2/2})ₛ(SiO_{4/2})ₜ, where R⁴ and R^{A} are as described above, and subscripts q, r, s, and t have average values such that 2≥q≥0, 4≥r≥0, 995≥s≥4, t=1, (q+r)=4, and (q+r+s+t) has a value sufficient to impart a viscosity >170 mPa·s measured by rotational viscometry (as described below with the test methods) to the branched polyorganosiloxane. Alternatively, viscosity may be >170 mPa·s to 1000 mPa·s, alternatively >170 to 500 mPa·s, alternatively 180 mPa·s to 450 mPa·s, and alternatively 190 mPa·s to 420 mPa·s. Suitable Q branched polyorganosiloxanes for starting material (B1-12) are known in the art and can be made by known methods, exemplified by those disclosed in U.S. Pat. No. 6,806,339 to Cray, et al. and U.S. Patent Publication 2007/0289495 to Cray, et al.

Alternatively, the branched vinyl-functional polyorganosiloxane may comprise formula (B1-13): [R^{A}R⁴₂Si—(O—SiR⁴₂)ₓ—O]_{(4-w)}—Si—[O—(R⁴₂SiO)ᵥSiR⁴₃]_{w}, where R^{A} and R⁴ are as described above; and subscripts v, w, and x have values such that 200≥v≥1, 2≥w≥0, and 200≥x≥1. Alternatively, in this formula (B1-13), each R⁴ is independently selected from the group consisting of methyl and phenyl. Branched polyorganosiloxane suitable for starting material (B1-13) may be prepared by known methods such as heating a mixture comprising a polyorganosilicate resin, and a cyclic polydiorganosiloxane or a linear polydiorganosiloxane, in the presence of a catalyst, such as an acid or phosphazene base, and thereafter neutralizing the catalyst.

Alternatively, the branched vinyl-functional polyorganosiloxane for starting material (B1-8) may comprise a T branched polyorganosiloxane of unit formula (B1-14): (R⁴₃SiO_{1/2})ₐₐ(R^{A}R⁴₂SiO_{1/2})_{bb}(R⁴₂SiO_{2/2})_{cc}(R^{A}R⁴SiO_{2/2})ₑₑ(R⁴SiO_{3/2})_{dd}, where R⁴ and R^{A} are as described above, subscript aa≥0, subscript bb>0, subscript cc is 15 to 995, subscript dd>0, subscript ee≥0, and a quantity (aa+bb+cc+dd+ee)≥4. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb≥0; alternatively 12≥bb≥3; alternatively 10≥bb>0; alternatively 7≥bb>1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may b 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd>0; alternatively 5≥dd>0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (B1-14) with a vinyl content of 0.1% to 1%, alternatively 0.2% to 0.6%, based on the weight of the silsesquioxane. Suitable T branched polyorganosiloxanes (silsesquioxanes) for starting material (B1-14) are exemplified by those disclosed in U.S. Pat. No. 4,374,967 to Brown, et al; U.S. Pat. No. 6,001,943 to Enami, et al.; U.S. Pat. No. 8,546,508 to Nabeta, et al.; and U.S. Pat. No. 10,155,852 to Enami.

Alternatively, (B) the vinyl-functional polyorganosiloxane may comprise a vinyl-functional polyorganosilicate resin, which comprises monofunctional units (“M” units) of formula R^{M}₃SiO_{1/2} and tetrafunctional silicate units (“Q” units) of formula SiO_{4/2}, where each R^{M} is an independently selected monovalent hydrocarbon group; each R^{M} may be independently selected from the group consisting of R⁴ and R^{A} as described above. Alternatively, each R^{M} may be selected from the group consisting of alkyl, vinyl, and aryl. Alternatively, each R^{M} may be selected from methyl, vinyl and phenyl. Alternatively, at least one-third, alternatively at least two thirds of the R^{M} groups are methyl groups. Alternatively, the M units may be exemplified by (Me₃SiO_{1/2}), (Me₂PhSiO_{1/2}), and (Me₂ViSiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M}₃)₄, where R^{M} is as described above, e.g., the neopentamer may be tetrakis(trimethylsiloxy) silane. ²⁹Si NMR and ¹³C NMR spectroscopies may be used to measure hydroxyl and alkoxy content and molar ratio of M and Q units, where said ratio is expressed as {M(resin)}/{Q(resin)}, excluding M and Q units from the neopentamer. M/Q ratio represents the molar ratio of the total number of triorganosiloxy groups (M units) of the resinous portion of the polyorganosilicate resin to the total number of silicate groups (Q units) in the resinous portion. M/Q ratio may be 0.5/1 to 1.5/1, alternatively 0.6/1 to 0.9/1.

The Mn of the polyorganosilicate resin depends on various factors including the types of hydrocarbon groups represented by R^{M} that are present. The Mn of the polyorganosilicate resin refers to the number average molecular weight measured using GPC, when the peak representing the neopentamer is excluded from the measurement. The Mn of the polyorganosilicate resin may be 1,500 to 30,000; alternatively 1,500 to 15,000; alternatively >3,000 to 8,000 Da. Alternatively, Mn of the polyorganosilicate resin may be 3,500 to 8,000 Da.

U.S. Pat. No. 8,580,073 at col. 3, line 5 to col. 4, line 31, and U.S. Patent Publication 2016/0376482 at paragraphs to are hereby incorporated by reference for disclosing MQ resins, which are suitable polyorganosilicate resins for use as starting material (B). The polyorganosilicate resin can be prepared by any suitable method, such as cohydrolysis of the corresponding silanes or by silica hydrosol capping methods. The polyorganosilicate resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M units and Q units. The resulting copolymers generally contain from 2 to 5 percent by weight of hydroxyl groups.

The intermediates used to prepare the polyorganosilicate resin may be triorganosilanes and silanes with four hydrolyzable substituents or alkali metal silicates. The triorganosilanes may have formula R^{M}₃SiX, where R^{M} is as described above and X represents a hydroxyl group or a hydrolyzable substituent, e.g., of formula (ZO_{1/2}) described above. Silanes with four hydrolyzable substituents may have formula SiX²₄, where each X² is independently selected from the group consisting of halogen, alkoxy, and hydroxyl. Suitable alkali metal silicates include sodium silicate.

The polyorganosilicate resin prepared as described above typically contain silicon bonded hydroxyl groups, e.g., of formula, HOSiO_{3/2}. The polyorganosilicate resin may comprise up to 3.5% of silicon bonded hydroxyl groups, as measured by FTIR spectroscopy and/or NMR spectroscopy, as described above. For certain applications, it may desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the polyorganosilicate resin can be converted to trihydrocarbon siloxane groups or to a different hydrolyzable group by reacting the silicone resin with a silane, disiloxane, or disilazane containing the appropriate terminal group. Silanes containing hydrolyzable groups may be added in molar excess of the quantity required to react with the silicon bonded hydroxyl groups on the polyorganosilicate resin.

Alternatively, the polyorganosilicate resin may further comprise 2% or less, alternatively 0.7% or less, and alternatively 0.3% or less, and alternatively 0.3% to 0.8% of units containing hydroxyl groups, e.g., those represented by formula XSiO_{3/2} where R^{M} is as described above, and X represents a hydrolyzable substituent and/or a silanol group, e.g., silicon bonded OH. The concentration of silanol groups (where X═OH) present in the polyorganosilicate resin may be determined using FTIR spectroscopy and/or NMR as described below.

For use herein, the polyorganosilicate resin further comprises one or more vinyl groups per molecule. The polyorganosilicate resin having vinyl groups may be prepared by reacting the product of Daudt, et al. with a vinyl group-containing endblocking agent and an endblocking agent free of aliphatic unsaturation, in an amount sufficient to provide from 3 to 30 mole percent of vinyl groups in the final product. Examples of endblocking agents include, but are not limited to, silazanes, siloxanes, and silanes. Suitable endblocking agents are known in the art and exemplified in U.S. Pat. No. 4,584,355 to Blizzard, et al.; U.S. Pat. No. 4,591,622 to Blizzard, et al.; and U.S. Pat. No. 4,585,836 Homan, et al. A single endblocking agent or a mixture of such agents may be used to prepare such resin.

Alternatively, the polyorganosilicate resin may comprise unit formula (B1-15): (R⁴₃SiO_{1/2})ₘₘ(R⁴₂R^{A}SiO_{1/2})ₙₙ(SiO_{4/2})ₒₒ(ZO_{1/2})ₕ, where Z, R⁴, and R^{A}, and subscript h are as described above and subscripts mm, nn and oo have average values such that mm≥0, nn≥0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/00≤4.

Alternatively, (B) the vinyl-functional polyorganosiloxane may comprise (B1-16) a vinyl-functional silsesquioxane resin, i.e., a resin containing trifunctional (T) units of unit formula: (R⁴₃SiO_{1/2})ₐ(R⁴₂R^{A}SiO_{1/2})_{b}(R⁴₂SiO_{2/2})_{c}(R⁴R^{A}SiO_{2/2})ₐ(R⁴SiO_{3/2})ₑ(R^{A}SiO_{3/2})_{f}(ZO_{1/2})ₕ; where R⁴ and R^{A} are as described above, subscript f>1, 2<(e+f)<10,000; 0<(a+b)/(e+f)<3; 0<(c+d)/(e+f)<3; and 0<h/(e+f)<1.5. Alternatively, the vinyl-functional silsesquioxane resin may comprise unit formula (B1-17): (R⁴SiO_{3/2})ₑ(R^{A}SiO_{3/2})_{f}(ZO_{1/2})ₕ, where R⁴, R^{A}, Z, and subscripts h, e and f are as described above. Alternatively, the vinyl-functional silsesquioxane resin may further comprise difunctional (D) units of formulae (R⁴₂SiO_{2/2})_{c}(R⁴R^{A}SiO_{2/2})_{d} in addition to the T units described above, i.e., a DT resin, where subscripts c and d are as described above. Alternatively, the vinyl-functional silsesquioxane resin may further comprise monofunctional (M) units of formulae (R⁴₃SiO_{1/2})ₐ(R⁴₂R^{A}SiO_{1/2})_{b}, i.e., an MDT resin, where subscripts a and b are as described above for unit formula (B1-1).

Vinyl-functional silsesquioxane resins are commercially available, for example. RMS-310, which comprises unit formula (B1-18): (Me₂ViSiO_{1/2})₂₅ (PhSiO_{3/2})₇₅ dissolved in toluene, is commercially available from Dow Silicones Corporation of Midland, Michigan, USA. Vinyl-functional silsesquioxane resins may be produced by the hydrolysis and condensation or a mixture of trialkoxy silanes using the methods as set forth in “Chemistry and Technology of Silicone” by Noll, Academic Press, 1968, chapter 5, p 190-245. Alternatively, vinyl-functional silsesquioxane resins may be produced by the hydrolysis and condensation of a trichlorosilane using the methods as set forth in U.S. Pat. No. 6,281,285 to Becker, et al. and U.S. Pat. No. 5,010,159 to Bank, et al. Vinyl-functional silsesquioxane resins comprising D units may be prepared by known methods, such as those disclosed in U.S. Patent Application 2020/0140619 and PCT Publication WO2018/204068 to Swier, et al.

Starting material (B) may be any one of the vinyl-functional polyorganosiloxanes described above. Alternatively, starting material (B) may comprise a mixture of two or more of the vinyl-functional polyorganosiloxanes.

### (C) Cobalt Carbonyl Catalyst

Starting material (C) used in the process described herein is a cobalt carbonyl catalyst. The cobalt carbonyl catalyst may be prepared as described above for step pre-1). The cobalt carbonyl catalyst may comprise HCo(CO)₄. Alternatively, the cobalt carbonyl catalyst may consist essentially of HCo(CO)₄. Alternatively, the cobalt carbonyl catalyst may consist of HCo(CO)₄. Alternatively, the cobalt carbonyl catalyst may comprise a product of heating the cobalt catalyst precursor selected from the group consisting of cobalt (II) acetylacetonate, dicobalt octacarbonyl, and a combination thereof in the presence of a gas comprising H₂, alternatively in the presence of starting material (A), the gas comprising CO and H₂, used in step 1). Without wishing to be bound by theory, it is thought that hydroformylation of vinyl-functional polyorganosiloxanes using this cobalt carbonyl catalyst in a suitable solvent under mild temperatures and pressures results in production of the propanal-functional polyorganosiloxane in high yield with good stability of the aldehyde moiety and good selectivity. Selectivity refers to the ratio of linear (N) to branched (I) isomers of the propanal-functional polyorganosiloxane. For example, a molar ratio of linear to branched isomers (N)/(I) ratio may be >1. Furthermore, stability means that side reactions such as degradation of the aldehyde moiety may be minimized under the hydroformylation reaction conditions.

The exact amount of the cobalt carbonyl catalyst depends on various factors including the selection of starting material (B) and the mode (e.g., batch or continuous) used for the process described herein. However, in a batch process the cobalt carbonyl catalyst may be used in an amount sufficient to provide at least 142 ppm Co based on weight of (B) the vinyl-functional polyorganosiloxane. Alternatively, the amount of (C) the cobalt carbonyl catalyst may be present in an amount sufficient to provide 142 ppm to 5,000 ppm, alternatively 142 ppm to 2,000 ppm, alternatively 142 ppm to 1,180 ppm of Co, on the same basis. Alternatively, the cobalt carbonyl catalyst may be used in an amount of at least 142 ppm, alternatively at least 150 ppm, alternatively at least 250 ppm, alternatively at least 500 ppm, and alternatively at least 750 ppm; while at the same time the cobalt carbonyl catalyst may be used in an amount up to 5000 ppm, alternatively up to 4,000 ppm, alternatively up to 3,000 ppm, alternatively up to 2,000 ppm, and alternatively up to 1,180 ppm.

The cobalt carbonyl catalyst may be free of organic ligands coordinated to cobalt other than the carbonyl groups (e.g., the carbonyl groups of formula C═O from the dicobalt octacarbonyl precursor or the groups derived from the cobalt acetylacetonate). Other ligands, such as organophosphine ligands may be detrimental to the performance of the cobalt carbonyl catalyst, therefore, the cobalt carbonyl catalyst may be free of organophosphorous ligands, e.g., organophosphine ligands such as tri-(tert-butyl)phosphine and/or tri-cyclohexylphosphine. For purposes of this application, “free of organophosphorous ligands” means that the starting materials intentionally added in step 1) contain no organophosphorous compounds or an amount of organophosphorous compounds non-detectable by phosphorous NMR.

### (D) Solvent

The hydroformylation process reaction may be carried out with a solvent to facilitate mixing and/or delivery of one or more of the starting materials described above, such as (C) the cobalt carbonyl catalyst and/or starting material (B) the vinyl-functional polyorganosiloxane, e.g., when a vinyl-functional polyorganosilioxane resin is selected for starting material (B), or both. The solvent is exemplified by aliphatic or aromatic hydrocarbons, which can dissolve the starting materials, e.g., toluene, xylene, benzene, hexane, heptane, decane, cyclohexane, or a combination of two or more thereof. Additional solvents include 1,4-dioxane, THF, dibutyl ether, diglyme, tetraglyme, and Texanol. Without wishing to be bound by theory, it is thought that solvent may be used to dissolve both the catalyst and vinyl-functional polyorganosiloxane and to reduce the viscosity of the starting materials. The amount of solvent is sufficient to make a one phase solution. The amount of solvent may be 5% to 70% based on weight of starting material (B) the vinyl-functional polyorganosiloxane.

### Propanal-Functional Polyorganosiloxane

The process described above produces a propanal-functional polyorganosiloxane. The propanal-functional polyorganosiloxane has, per molecule, at least one propanal group covalently bonded to silicon. Alternatively, the propanal-functional polyorganosiloxane may have, per molecule, more than one propanal group covalently bonded to silicon. The propanal group covalently bonded to silicon may have formula:

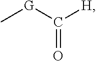

where G is a divalent hydrocarbon group free of aliphatic unsaturation that has 2 carbon atoms. G may be linear or branched. Examples of divalent hydrocarbyl groups for G include a linear group of formula-CH₂—CH₂— and a branched group of formula

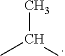

The propanal-functional polyorganosiloxane may be any one of the formulas above for (B) the vinyl-functional polyorganosiloxane wherein at least one R^{A} is replaced with a propanal group.

The propanal-functional polyorganosiloxane may be cyclic, linear, branched, resinous, or a combination of two or more thereof. Said propanal-functional polyorganosiloxane may comprise unit formula (E1-1):
(R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(SiO_{4/2})_{g}(ZO_{1/2})ₕ; where each R^{Ald} is an independently selected propanal group of the formula

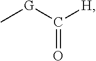

as described above, and G, R⁴, Z, and subscripts a, b, c, d, e, f, g, and h are as described above.

Alternatively, (E) the propanal-functional polyorganosiloxane may comprise (E1-2) a linear polydiorganosiloxane having, per molecule, at least one silicon bonded propanal group; alternatively at least two silicon bonded propanal groups (e.g., when in the formula (E1-1) for the propanal-functional polyorganosiloxane above, subscripts e=f=g=0). For example, said polydiorganosiloxane may comprise unit formula (E1-3):
(R⁴₃SiO_{1/2})ₐ(R^{Ald}R⁴₂SiO_{1/2})_{b}(R⁴₂SiO_{2/2})_{c}(R^{Ald}R⁴SiO_{2/2}), where R^{Ald}, R⁴, and subscripts a, b, c, and d are as described above.

Alternatively, the linear propanal-functional polydiorganosiloxane of unit formula (E1-3) may be selected from the group consisting of: unit formula (E1-4):
(R⁴₂R^{Ald}SiO_{1/2})₂(R⁴₂SiO_{2/2})ₘ(R⁴R^{Ald}SiO_{2/2})ₙ, unit formula (E1-5):
(R⁴₃SiO_{1/2})₂(R⁴₂SiO_{2/2})ₒ(R⁴R^{Ald}SiO_{2/2})ₚ, or a combination of both (E1-4) and (E1-5), where in formulae (E1-4) and (E1-5), R⁴, R^{Ald}, and subscripts m, n, o, and p are as described above.

The linear propanal-functional polydiorganosiloxane (E) may comprise an propanal-functional polydiorganosiloxane such as i) bis-dimethyl(propanal)siloxy-terminated polydimethylsiloxane, ii) bis-dimethyl(propanal)siloxy-terminated poly(dimethylsiloxane/methyl(propanal)siloxane), iii) bis-dimethyl(propanal)siloxy-terminated polymethyl(propanal)siloxane, iv) bis-trimethylsiloxy-terminated poly(dimethylsiloxane/methyl(propanal)siloxane), v) bis-trimethylsiloxy-terminated polymethyl(propanal)siloxane, vi) bis-dimethyl(propanal)siloxy-terminated poly(dimethylsiloxane/methylphenylsiloxane/methyl(propanal)siloxane), vii) bis-dimethyl(propanal)siloxy-terminated poly(dimethylsiloxane/methylphenylsiloxane), viii) bis-dimethyl(propanal)siloxy-terminated poly(dimethylsiloxane/diphenylsiloxane), ix) bis-phenyl,methyl,(propanal)-siloxy-terminated polydimethylsiloxane, and x) a combination of two or more of i) to ix).

Alternatively, (E) the propanal-functional polyorganosiloxane may be cyclic, e.g., when in unit formula (E1-1), subscripts a=b=c=e=f=g=h=0. The cyclic propanal-functional polydiorganosiloxane may have unit formula (E1-6): (R⁴R^{Ald}SiO_{2/2})_{d}, where R^{Ald}, and R⁴, and subscript d are as described above. Examples of cyclic propanal-functional polydiorganosiloxanes include 2,4,6-trimethyl-2,4,6-tri (propanal)-cyclotrisiloxane, 2,4,6,8-tetramethyl-2,4,6,8-tetra(propanal)-cyclotetrasiloxane, 2,4,6,8,10-pentamethyl-2,4,6,8,10-penta (propanal)-cyclopentasiloxane, and 2,4,6,8,10,12-hexamethyl-2,4,6,8,10,12-hexa (propanal)-cyclohexasiloxane.

Alternatively, the cyclic propanal-functional polydiorganosiloxane may have unit formula (E1-7): (R⁴₂SiO_{2/2})_{c}(R⁴R^{Ald}SiO_{2/2})_{d}, where R⁴, R^{Ald}, and subscripts c and d are as described above.

Alternatively, (E) the propanal-functional polyorganosiloxane may be branched. The branched propanal-functional polyorganosiloxane may have general formula (E1-8): R^{Ald}SiR¹²₃, where R^{Ald} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100 with the proviso that R¹², R¹⁴, and R¹⁵ are selected such that the branched propanal-functional polyorganosiloxane has at least 4 silicon atoms per molecule. At least two of R¹² may be —OSi(R¹⁴)₃. Alternatively, all three of R¹² may be —OSi(R¹⁴)₃.

Alternatively, in formula (E1-8) when each R¹² is —OSi(R¹⁴)₃, each R¹⁴ may be —OSi(R¹⁵)₃ moieties such that the branchedpropanal-functional polyorganosiloxane has the following structure (E1-9):

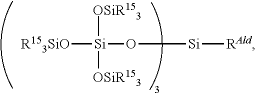

where R^{Ald} and R¹⁵ are as described above.

Alternatively, in formula (E1-8), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched propanal-functional polyorganosiloxane has the following structure (E1-10):

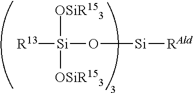

where R^{Ald}, R¹³, and R¹⁵ are as described above.

Alternatively, in formula (E1-8), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of R¹² are —OSiR¹³(R¹⁴)₂. Alternatively, each R¹⁴ in —OSiR¹³(R¹⁴)₂ may be —OSi(R¹⁵)₃ such that the branched propanal-functional polyorganosiloxane has the following structure (E1-11):

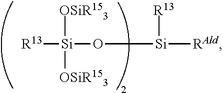

where R^{Ald}, R¹³, and R¹⁵ are as described above. Examples of propanal-functional branched polyorganosiloxanes include tris(trimethylsiloxy) silane propanal, which has formula:

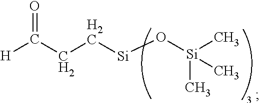

3-(1,1,1,3,5,7,9,9,9-nonamethyl-3,7-bis((trimethylsilyl)oxy)pentasiloxan-5-yl)propanal, which has formula

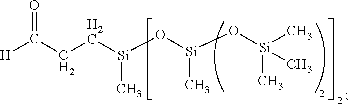

and 3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl)propanal, which has formula

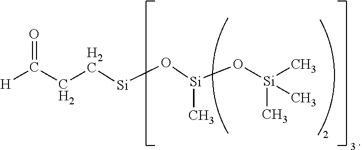

Alternatively, (E) the propanal-functional polyorganosiloxane may be branched, such as the branched propanal-functional polyorganosiloxane with the dendrimeric structure described above and/or a branched propanal-functional polyorganosiloxane that may have, e.g., more propanal-groups per molecule. Alternatively, the branched propanal-functional polyorganosiloxane may have (in formula (E1-1)) a quantity (e+f+g) sufficient to provide >0 to 5 mol % of trifunctional and/or quadrifunctional units to the branched propanal-functional polyorganosiloxane.

For example, the branched propanal-functional polyorganosiloxane may comprise a Q branched polyorganosiloxane of unit formula (E1-12):
(R⁴₃SiO_{1/2})_{q}(R⁴₂R^{Ald}SiO_{1/2})ᵣ(R⁴₂SiO_{2/2})ₛ(SiO_{4/2})ₜ, where R⁴, R^{Ald}, and subscripts q, r, s, and t are as described above.

Alternatively, the branched propanal-functional polyorganosiloxane may comprise formula (E1-13): [R^{Ald}R⁴₂Si—(O—SiR⁴₂)ₓ—O]_{(4-w)}—Si—[O—(R⁴₂SiO)ᵥSiR⁴₃]w, where R^{Ald}, R⁴, and subscripts v, w, and x are as described above.

Alternatively, the branched propanal-functional polyorganosiloxane of formula (E1-8) may comprise a T branched polyorganosiloxane (silsesquioxane) of unit formula (E1-14): (R⁴₃SiO_{1/2})ₐₐ(R^{Ald}R⁴₂SiO_{1/2})_{bb}(R⁴₂SiO_{2/2})_{cc}(R^{Ald}R⁴SiO_{2/2})ₑₑ(R⁴SiO_{3/2})_{dd}, where R⁴, R^{Ald}, and subscripts aa, bb, cc, dd, and ee are as described above.

Alternatively, (E) the propanal-functional polyorganosiloxane may comprise a propanal-functional polyorganosiloxane resin, such as a propanal-functional polyorganosilicate resin and/or a propanal-functional silsesquioxane resin. The polyorganosilicate resin may comprise unit formula (E1-15): (R⁴₃SiO_{1/2})ₘₘ(R⁴₂R^{Ald}SiO_{1/2})ₙₙ(SiO_{4/2})ₒₒ(ZO_{1/2}), where Z, R⁴, R^{Ald}, and subscripts h, mm, nn, and oo are as described above.

Alternatively, (E) the propanal-functional polyorganosiloxane may comprise (E1-16) an propanal-functional silsesquioxane resin, i.e., a resin containing trifunctional (T′) units of unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})ₐ(R⁴SiO_{3/2})ₑ(R^{Ald}SiO_{3/2})_{f}(ZO_{1/2})ₕ; where R⁴, R^{Ald}, and subscripts a, b, c, d, e, f, and h are as described above. Alternatively, the propanal-functional silsesquioxane resin may comprise unit formula (E1-17): (R⁴SiO_{3/2})ₑ(R^{Ald}SiO_{3/2})_{f}(ZO_{1/2})ₕ, where R⁴, R^{Ald}, Z, and subscripts h, e and f are as described above. Alternatively, the propanal-functional silsesquioxane resin may further comprise difunctional (D′) units of formulae (R⁴₂SiO_{2/2})_{c}(R⁴R^{Ald}SiO_{2/2})_{d} in addition to the T units described above, i.e., a D′T′ resin, where R⁴, R^{Ald}, and subscripts c and d are as described above. Alternatively, the propanal-functional silsesquioxane resin may further comprise monofunctional (M′) units of formulae (R⁴₃SiO_{1/2})ₐ(R⁴₂R^{Ald}SiO_{1/2})_{b}, i.e., an M′D′T′ resin, where R⁴, R^{Ald}, and subscripts a and b are as described above for unit formula (B1-1).

### EXAMPLES

The following examples are provided to illustrate the invention to those skilled in the art, and are not to be construed as limiting the scope of the invention set forth in the claims. The starting materials used in these examples are summarized below in Table 1.

TABLE 1
Starting Materials

| | | Chemical Description, Chemical | |
|---|---|---|---|
| Type | Product Name | formula, or Structure | Source |
| (A-1) | Syngas | 1:1 molar ratio of H₂:CO | Airgas |
| Solvent | 1,4-Dioxane | 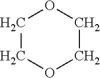 | Fisher Chemical |
| (B-1) | M^{vi}D₁₇₈M^{vi} | Bis-vinyl terminated | Dow |
| | | polydimethylsiloxane with unit | Silicones |
| | | formula M^{Vi}₂D₁₇₈ | Corporation |
| (B-2) | M^{Vi}D₅₄₃D^{Vi}₁₄₇M^{Vi} | Bis(dimethyl^{vi}nylsiloxy-terminated) | Dow |
| | | poly(dimethyl/methylvinyl)siloxane | Silicones |
| | | copolymer with unit formula | Corporation |
| | | M^{Vi}₂D₅₄₃D^{Vi}₁₄₇ | |
| (B-3) | M^{Vi}D₁₄₁D^{Vi}₂M^{Vi} | Bis(dimethyl^{vi}nylsiloxy-terminated) | Dow |
| | | poly(dimethyl/methylvinyl)siloxane | Silicones |
| | | copolymerwith unit formula | Corporation |
| | | M^{Vi}₂D₁₄₁D^{Vi}₂ | |
| Comparative | M^{Vi}M^{Vi} | 1,3-diviny1,1,3,3- | DOWSIL ™ |
| ^{vi}nylsiloxane | | tetramethydisiloxane | 4-2776 |
| | | | from Dow |
| | | | Silicones |
| | | | Corporation |
| Comparative | Vinyl methyl | 1,1,1,3,5,5,5-heptamethyl-3- | Sigma- |
| ^{vi}nylsiloxane | bis(trimethylsiloxy)silane | vinyltri-siloxane | Aldrich |
| | with unit formula | | |
| | MD^{Vi}M | | |
| Catalyst | Co(acac)₂ | Bis(Acetylacetonato)cobalt with | Sigma- |
| precursor | | MW 257.15 | Aldrich |
| Ligand 1 | t-Bu₃P | tri-(tert-butyl)phosphine | Sigma- |
| | | | Aldrich |
| Ligand 2 | Cy₃P | tri-cyclohexylphosphine | Sigma- |
| | | | Aldrich |

In this Reference Example 1, Co catalyst was prepared as follows. Co(acac)₂ (31 mg; 0.12 mmol; MW 257.15) was dissolved in 1,4-dioxane (25 g) and charged by syringe into a Parr reactor and purged two times with syngas at 100 psi (689.5 kPa). Then the catalyst was heated at 700 psi (4826.3 kPa) and 140° C. for 30 min. The reactor was cooled to 30-40° C.

Reference Example 2, Co catalyst 2 was prepared as follows. Co(acac)₂ (257 mg; 1 mmol) was dissolved in 1,4-dioxane (25 g), charged by syringe into a Parr reactor and purged two times with syngas at 100 psi (689.5 kPa). Then the catalyst was heated at 700 psi (4826.3 kPa) and 140° C. for 30 min. The reactor was cooled to 30-40° C.

In this Comparative Example 1, hydroformylation reaction was performed at 100° C., as follows. Starting material (B-1) M^{vi}D₁₇₈M^{vi} (10 g) was mixed with 1,4-dioxane (15 g) in a jar and purged with bubbling nitrogen for 5 minutes. This solution was transferred to the cooled and vented Parr reactor containing the Co catalyst prepared as described in Reference Example 1. Syngas was charged (300 psi, 2068.4 kPa) and the temperature was increased to 100° C. with stirring. Hydroformylation was carried out at 700 psi (4826.3 kPa) of syngas and 100° C. for 2 h. Then the reactor was cooled to 30-40° C., vented, and a sample was taken and analyzed by NMR. The analysis revealed a complete conversion of the starting material (B-1) M^{vi}D₁₇₈M^{vi} and partial decomposition of the resulting aldehyde groups due to the secondary transformations (Table 2).

Comparative Example 2 was performed similarly to Example 1 except that the hydroformylation reaction temperature was 90° C. in place of 100° C. The NMR analysis of the reaction product revealed a complete conversion of the starting material (B-1) M^{vi}D₁₇₈M^{vi} and partial decomposition of the aldehyde due to the secondary transformations (Table 2).

In this Comparative Example 3, Co(acac)₂ (31 mg; 0.12 mmol; MW 257.15) was dissolved in 1,4-dioxane (25 g) and charged by syringe into a Parr reactor and purged two times with syngas at 100 psi. Then the catalyst was heated at 500 psi (3447.4 kPa) and 140° C. for 30 min. The reactor was cooled to 30-40° C., syngas vented, and the solution inside the reactor was removed by syringe.

The reactor was opened and neat (B-1) M^{vi}D₁₇₈M^{vi} (25 g) was quickly charged. Then the catalyst solution was transferred back to the Parr reactor. Syngas was introduced (50 psi, 344.7 kPa) and the temperature was increased to 90° C. with stirring. Hydroformylation was carried out at 150 psi (1034.2 kPa) of syngas and 90° C. for 2 h. Then the reactor was cooled to 30-40° C., vented, and a sample was taken and analyzed by NMR. The analysis revealed no reaction (Table 2).

In this Working Example 4, (B-1) M^{vi}D₁₇₈M^{vi} (10 g) was mixed with 1,4-dioxane (15 g) in a jar and purged with bubbling nitrogen for 5 minutes. This solution was transferred to the cooled and vented Parr reactor containing the Co catalyst (prepared as described in Reference Example 1). Syngas was charged (300 psi, 2068.4 kPa) and the temperature was increased to 70° C. with stirring. Hydroformylation was carried out at 700 psi (4826.3 kPa) of syngas and 70° C. for 30 min. Then the reactor was cooled to 30-40° C., vented, and a sample was taken and analyzed by NMR. The analysis revealed partial conversion of the starting material (B-1), MᵥᵢD₁₇₈M^{vi}, and no aldehyde secondary products. Samples were also taken and analyzed at 2 h and 4 h. After 4 h the conversion was 73% with N/I=1.3 (Table 2).

Working Example 5 was performed similarly to Example 4 but the hydroformylation reaction temperature was 80° C. in place of 70° C. and pressure was 400 psi (2757.9 kPa) in place of 700 psi (4826.3 kPa). The analysis revealed partial conversion of the starting M^{vi}D₁₇₈M^{vi} in 0.5 h and 2 h. After 2 h the conversion was 73% with N/I=1.5 (Table 6).

In this Comparative Example 6, Co(acac)₂ (100 mg; 0.39 mmol; MW 257.15) was dissolved in 1,4-dioxane (25 g) under nitrogen, and to this solution was added tri-(tert-butyl)phosphine (404 mg; 2 mmol). The mixture was charged by syringe into a Parr reactor and purged two times with syngas at 100 psi. Then the catalyst was activated at 700 psi (4826.3 kPa) and 140° C. for 30 min. The reactor was cooled to 30-40° C.

M^{vi}D₁₇₈M^{vi} (10 g) was mixed with 1,4-dioxane (15 g) in a jar and purged with bubbling nitrogen for 5 minutes. This solution was transferred to the cooled and vented Parr reactor containing the activated Co-tri-(tert-butyl)phosphine catalyst. Syngas was charged (300 psi (2068.4 kPa)) and the temperature was increased to 80° C. with stirring. Hydroformylation reaction was attempted at 700 psi (4826.3 kPa) of syngas and 80° C. for 4 hours. Then the reactor was cooled to 30-40° C., vented, and a sample was taken and analyzed by NMR. The analysis revealed no reaction (Table 2).

In this Comparative Example 7, to Co(acac)₂ (100 mg; 0.39 mmol) dissolved in 1,4-dioxane (25 g) under nitrogen was added tri-cyclohexylphosphine (561 mg; 2 mmol). The mixture was charged by syringe into a Parr reactor and purged two times with syngas at 100 psi. Then the catalyst was activated at 700 psi (4826.3 kPa) and 140° C. for 30 min. The reactor was cooled to 30-40° C.

Starting material (B-1) M^{vi}D₁₇₈M^{vi} (10 g) was mixed with 1,4-dioxane (15 g) in a jar and purged with bubbling nitrogen for 5 minutes. This solution was transferred to the cooled and vented Parr reactor containing the activated Co-tri-cyclohexylphosphine catalyst. Syngas was charged (300 psi (2068.4 kPa)) and the temperature was increased to 80° C. with stirring. Hydroformylation reaction was attempted at 700 psi (4826.3 kPa) of syngas and 80° C. for 4 hours. Then the reactor was cooled to 30-40° C., vented, and a sample was taken and analyzed by NMR. The analysis revealed no reaction (Table 2).

In this Comparative Example 8, MD^{vi}M was reacted as follows: 1,1,1,3,5,5,5-heptamehyl-3-vinyltrisiloxane (25 g) was purged with bubbling nitrogen for 5 minutes and then transferred to the cooled and vented Parr reactor containing the activated Co catalyst (prepared as described above in Reference Example 2). Syngas was charged (300 psi (2068.4 kPa)) and the temperature was increased to 80° C. with stirring. Hydroformylation reaction attempted at 700 psi (4826.3 kPa) of syngas and 80° C. for 4 h. Then the reactor was cooled to 30-40° C., vented, and a sample was taken and analyzed by NMR. The analysis revealed no reaction (Table 2).

In this Comparative Example 9, M^{vi}M^{vi} was reacted as follows: 1,1,3,3-tetramethyl-1,3-divinyldisiloxane (25 g) was purged with bubbling nitrogen for 5 minutes and then transferred to the cooled and vented Parr reactor containing the activated Co catalyst (prepared as described above in Reference Example 2). Syngas was charged (300 psi (2068.4 kPa)) and the temperature was increased to 90° C. with stirring. Hydroformylation reaction was attempted at 700 psi (4826.3 kPa) of syngas and 90° C. for 4 h. Then the reactor was cooled to 30-40° C., vented, and a sample was taken and analyzed by NMR. The analysis revealed only 1% conversion (Table 2).

In this Working Example 10, (B-3) M^{Vi}D₁₄₁D^{Vi}₂M^{Vi} (25 g) was purged with bubbling nitrogen for 5 minutes and then transferred to the cooled and vented Parr reactor containing the Co catalyst 2 (prepared as described above in Reference Example 2). Syngas was charged (300 psi (2068.4 kPa)) and the temperature was increased to 80° C. with stirring. Hydroformylation reaction was carried out at 700 psi (4826.3 kPa) of syngas and 80° C. for 2 h. The NMR analysis revealed 97% conversion with N/I=2.3. After 4 h, the conversion was 100% with N/I=2.6 (Table 2).

In this Working Example 11, (B-1) M^{vi}D₁₇₈M^{vi} (25 g) was purged with bubbling nitrogen for 5 min, and transferred to the cooled and vented Parr reactor containing the Co catalyst 2 (prepared as described above in Reference Example 2). Syngas was charged (300 psi (2068.4 kPa)) and the temperature was increased to 70° C. with stirring. Hydroformylation was carried out at 700 psi (4826.3 kPa) of syngas and 70° C. for 2 h. The NMR analysis revealed 33% conversion with N/I=1.5. After 4 h, the conversion was 71% with N/I=1.65 (Table 2).

In this Working Example 12, (B-1) M^{vi}D₁₇₈M^{vi} (10 g) was mixed with 1,4-dioxane (15 g) in a jar and purged with bubbling nitrogen for 5 minutes. This solution was transferred to the cooled and vented Parr reactor containing the Co catalyst 2 (prepared as described above in Reference Example 2). Syngas was charged (300 psi (2068.4 kPa)) and the temperature was increased to 70° C. with stirring. Hydroformylation was carried out at 700 psi (4826.3 kPa) of syngas and 70° C. for 2 h. The NMR analysis revealed 82% conversion with N/I=2.3. After 4 h, the conversion was 100% with N/I=2.3 (Table 2).

In this Working Example 13, (B-2) M^{Vi}D₅₄₃D^{Vi}₁₄₇M^{Vi} (10 g) was mixed with 1,4-dioxane (15 g) in a jar and purged with bubbling nitrogen for 5 minutes. This solution was transferred to the cooled and vented Parr reactor containing the Co catalyst 2 (prepared as described above in Reference Example 2). Syngas was charged (300 psi (2068.4 kPa)) and the temperature was increased to 70° C. with stirring. Hydroformylation was carried out at 700 psi (4826.3 kPa) of syngas and 70° C. The NMR analysis revealed after 2 h 14% conversion which increased after 4 h to 21%. The conversion after 8 h was 39% (Table 2).

TABLE 2
Hydroformylation Reaction Conditions and Results

| Entry | | (B) | Co | Ligand, | Temp, | Press., | Time, | Conv, | |
|---|---|---|---|---|---|---|---|---|---|
| # | (B) | wt % | ppm | L/Co | ° C. | psi | h | % | N/I |
| CE 1⁺^{₊} | M^{vi}D₁₇₈M^{vi} | 20 | 142 | None | 100 | 700 | 2 | 100 | N/D |
| CE 2⁺^{₊} | M^{vi}D₁₇₈M^{vi} | 20 | 142 | None | 90 | 700 | 2 | 100 | N/D |
| CE 3* | M^{vi}D₁₇₈M^{vi} | 50 | 142 | None | 90 | 150 | 2 | 0 | N/D |
| WE 4 | M^{vi}D₁₇₈M^{vi} | 20 | 142 | None | 70 | 700 | 0.5 | 31 | N/D |
| WE 4 | M^{vi}D₁₇₈M^{vi} | 20 | 142 | None | 70 | 700 | 2 | 63 | 1.2 |
| WE 4 | M^{vi}D₁₇₈M^{vi} | 20 | 142 | None | 70 | 700 | 4 | 73 | 1.3 |
| WE 5 | M^{vi}D₁₇₈M^{vi} | 20 | 142 | None | 80 | 400 | 0.5 | 18 | N/D |
| WE 5 | M^{vi}D₁₇₈M^{vi} | 20 | 142 | None | 80 | 400 | 2 | 73 | 1.5 |
| CE 6* | M^{vi}D₁₇₈M^{vi} | 20 | 460 | t-Bu₃P, | 80 | 700 | 4 | | |
| | | | | 5.1 | | | | | |
| CE 7* | M^{vi}D₁₇₈M^{vi} | 20 | 460 | Cy₃P, 5.1 | 80 | 700 | 4 | | |
| CE 8* | MD^{vi}M | 50 | 1180 | None | 80 | 700 | 4 | 0 | |
| CE 9** | M^{vi}M^{vi} | 50 | 1180 | none | 90 | 700 | 4 | 1 | |
| WE 10⁺ | (B-3) | 50 | 1180 | none | 80 | 700 | 2 | 97 | 2.3 |
| WE 10 | (B-3) | 50 | 1180 | none | 80 | 700 | 4 | 100 | 2.6 |
| WE 11 | M^{vi}D₁₇₈M^{vi} | 50 | 1180 | none | 70 | 700 | 2 | 33 | 1.5 |
| WE 11 | M^{vi}D₁₇₈M^{vi} | 50 | 1180 | none | 70 | 700 | 4 | 71 | 1.65 |
| WE 12 | M^{vi}D₁₇₈M^{vi} | 20 | 1180 | none | 70 | 700 | 2 | 82 | 2.3 |
| WE 12 | M^{vi}D₁₇₈M^{vi} | 20 | 1180 | none | 70 | 700 | 4 | 100 | 2.3 |
| WE 13 | (B-2) | 20 | 1180 | none | 70 | 700 | 2 | 14 | N/D |
| WE 13 | (B-2) | 20 | 1180 | none | 70 | 700 | 4 | 21 | N/D |
| WE 13 | (B-2) | 20 | 1180 | none | 70 | 700 | 8 | 39 | N/D |

In Table 2 above,
*denotes no reaction.
**denotes traces.
⁺denotes terminal and pendant propanal groups formed.
⁺^{₊}denotes degredation of the propanal groups occurred.
N/D means not determined.

In Table 2 above, * denotes no reaction. ** denotes traces. + denotes terminal and pendant propanal groups formed. ++ denotes degradation of the propanal groups occurred. N/D means not determined.

### INDUSTRIAL APPLICABILITY

The inventors surprisingly found that the process described herein can be run under milder conditions than previous hydroformylation reaction processes. For example, in the process of this invention temperature of <90° C. and pressure≤700 psi (4826.3 kPa) allows for production of propanal-functional polyorganosiloxanes with minimal or no degradation and/or crosslinking of the propanal-functional polyorganosiloxanes and reduced energy consumption as compared to previous processes, which may run at significantly higher temperatures and/or pressures. The improved yields (because of minimizing side reactions that degrade and/or crosslink the propanal-functional polyorganosiloxane product) and reduced energy consumption make the present process more sustainable than processes that conduct hydroformylation reaction at higher temperatures.

### DEFINITIONS AND USAGE OF TERMS

All amounts, ratios, and percentages herein are by weight, unless otherwise indicated. The amounts of all starting materials in a composition total 100 weight % unless otherwise indicated. The articles ‘a’, ‘an’, and ‘the’ include both the singular and the plural, unless otherwise indicated. The symbol ‘<’ means “less than”. The symbol ‘>’ means “greater than”. The symbol ‘≤’ means “less than or equal to”. The symbol ‘≥’ means “greater than or equal to”. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The abbreviations used herein have the definitions in Table 11.

TABLE 11
Abbreviations

| Abbreviation | Definitions |
|---|---|
| acac | acetyl acetonate |
| ° C. | degrees Celsius |
| D | Difunctional siloxy unit |
| D^{vi} | Difunctional siloxy unit, vinyldimethylsiloxy unit of |
| | formula (Vi)(Me)SiO_{2/2} |
| g | gram |
| GPC | gel permeation chromatography |
| h | hour |
| kPa | kiloPascals |
| M | Monofunctional siloxy unit |
| M^{Pr-ald} | Monofunctional siloxy unit, propanaldimethylsiloxy |
| | unit of formula (Pr-ald)(Me₂)SiO_{1/2} |
| M^{vi} | Monofunctional siloxy unit, vinyldimethylsiloxy unit of |
| | formula (Vi)(Me₂)SiO_{1/2} |
| Me | methyl |
| mg | milligram |
| min | minute |
| mL | milliliter |
| mm | millimeter |
| Mmol | millimole |
| Mn | number average molecular weight measured by GPC |
| Mw | weight average molecular weight measured by GPC |
| mPa · s | milliPascal seconds |
| NMR | nuclear magnetic resonance |
| Ph | phenyl |
| Pr-ald | Propyl-aldehyde or propanal |
| psi | pounds per square inch |
| Q | Tetrafunctional siloxy unit of formula SiO_{4/2} |
| RPM | revolutions per minute |
| RT | room temperature of 25 ± 5° C. |
| T | Trifunctional siloxy unit |
| THF | tetrahydrofuran |
| μm | micrometer |
| Vi | vinyl |
| ppm | parts per million by weight |

The following test methods were used herein. ¹H NMR: ¹H NMR spectra were recorded on a Varian 400-NMR spectrometer (400 MHz, ¹H) with an autosampler. Chemical shifts (δ) were referenced to internal solvent resonances and are reported relative to tetramethyl silane. Predicted chemical shifts for ¹H spectra were obtained using Perkin-Elmer ChemDraw Version 18.2.0.48 software. ²⁹Si NMR: Vinyl content of starting material (B) can be measured by the technique described in “The Analytical Chemistry of Silicones” ed. A. Lee Smith, Vol. 112 in Chemical Analysis, John Wiley & Sons, Inc. (1991). Viscosity: Viscosity may be measured at 25° C. at 0.1 to 50 RPM on a Brookfield DV-III cone & plate viscometer with #CP-52 spindle, e.g., for polymers (such as (B) vinyl-functional polyorganosiloxanes and (E) propanal-functional polyorganosiloxanes) with viscosity of 120 mPa·s to 250,000 mPa·s. One skilled in the art would recognize that as viscosity increases, rotation rate decreases and would be able to select appropriate spindle and rotation rate.

### Problems to be Addressed:

The lack of a good catalyst system constitutes a significant challenge for the commercialization of a hydroformylation process for vinyl-functional polyorganosiloxanes compounds. Previously proposed processes suffer from one or more of the following drawbacks: cost and availability of Rhodium catalysts and poor performance such as slow reaction rate, low linear selectivity, high catalyst loading, and harsh reaction conditions with other catalysts. Slow reaction rate leads to low productivity. The high catalyst loading used would lead to difficulties in catalyst recycling. Low linear selectivity would promote product decomposition since the branched product tends to undergo Brook rearrangement reaction. Furthermore, harsh conditions, such as temperature ≥90° C. can result in degradation and/or crosslinking of the propanal-functional polyorganosiloxane.

The present hydroformylation process provides one or more benefits over previously proposed processes; i.e., faster reaction rate, improved yield, good stability and good selectivity, to achieve these. As shown in the examples above, the hydroformylation process can produce a reaction fluid, which comprises polyorganosiloxanes having silicon bonded propanal groups. Linear and branched propanal groups may be formed. The molar ratio of the linear propanal-functional moiety/the branched propanal-functional moiety (N/I ratio)>1. Furthermore, the hydroformylation process is robust and provides these benefits with a wide range of vinyl-functional polyorganosiloxane starting materials.

1. A process for preparing a propanal-functional polyorganosiloxane, said process comprising:
1) combining starting materials comprising
(A) a gas comprising hydrogen and carbon monoxide,
(B) an vinyl-functional polyorganosiloxane with at least 4 siloxane units per molecule, and
(C) a cobalt carbonyl catalyst in an amount sufficient to provide at least 142 ppm of cobalt metal, and
(D) a solvent;
wherein step 1) is performed
at a temperature of 50° C. to <90° C.;
at a pressure of >150 psi to 700 psi; and
for a time of at least 30 minutes; thereby preparing a reaction fluid comprising the propanal-functional polyorganosiloxane.

2. The process of claim 1, where the process further comprises an additional step before step 1), where the additional step comprises:
pre-1) forming (C) the cobalt carbonyl catalyst by a method comprising:
i) combining a cobalt catalyst precursor selected from the group consisting of cobalt (II) acetylacetonate and Co₂(CO)₈ and a solvent, thereby forming a solution, and
ii) heating the solution at a temperature of 100° C. to 150° C. at a pressure of 600 psi to 800 psi for a time of 10 minutes to 60 minutes, thereby forming a product comprising the (C) the cobalt carbonyl catalyst.

3. The process of claim 2, where step i) and/or step ii) is performed in the presence of (A) the gas comprising hydrogen and carbon monoxide.

4. The process of claim 2, further comprising step iii), cooling the product comprising (C) the cobalt carbonyl catalyst to 25° C. to 50° C. before step 1).

5. The process of claim 1, where (B) the vinyl-functional polyorganosiloxane has unit formula:
(R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(SiO_{4/2})_{g}(Z O_{1/2})ₕ; where each R^{A} is a vinyl group; each R⁴ is independently selected from the group consisting of an alkyl group of 1 to 18 carbon atoms, an aryl group of 6 to 18 carbon atoms, and an hydrocarbonoxy group of 1 to 18 carbon atoms; each Z is independently selected from the group consisting of a hydrogen atom and R⁵, where each R⁵ is independently selected from the group consisting of alkyl groups of 1 to 18 carbon atoms and aryl groups of 6 to 18 carbon atoms; subscripts a, b, c, d, e, f, and g represent numbers of each unit in the unit formula and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, 10,000≥(a+b+c+d+e+f+g)≥100, and a quantity (b+d+f)≥1.

6. The process of claim 5, where the vinyl-functional polyorganosiloxane is linear and comprises unit formula:
(R⁴₃SiO_{1/2})ₐ(R⁴₂R^{A}SiO_{1/2})_{b}(R⁴₂SiO_{2/2})_{c}(R⁴R^{A}SiO_{2/2})_{d}, where each R⁴ is an independently selected alkyl group of 1 to 12 carbon atoms, a quantity (a+b)=2, a quantity (b+d)≥1, and 700≥(a+b+c+d)≥140.

7. The process of claim 5, where each R⁴ is independently selected from the group consisting of methyl and phenyl.

8. The process of claim 7, where each R⁴ is methyl.

9. The process of claim 1, where (C) the cobalt carbonyl catalyst comprises cobalt tetracarbonyl hydride of formula HCo(CO)₄.

10. The process of claim 1, where (C) the cobalt carbonyl catalyst is free of organophosphorous ligands.

11. The process of claim 1, where in step 1) the temperature is 70° C. to 80° C.

12. The process of claim 1, where in step 1) the pressure is 400 psi to 700 psi.

13. The process of claim 1, where in step 1) the time is 2 hours to 8 hours.

14. The process of claim 1, where in step 1), (C) the cobalt carbonyl catalyst is present in an amount sufficient to provide 142 ppm to 1180 ppm of cobalt metal.
